(19) United States
(12) Patent Application Publication
(10) Pub. No.: US 2022/0382798 A1
(43) Pub. Date: Dec. 1, 2022

(54) SYSTEMS AND METHODS FOR CONTENT ITEM DISTRIBUTION AND INTERACTION

(71) Applicants: Jake Kavaler, Pound Ridge, NY (US); Zachary Spar, Chappaqua, NY (US)

(72) Inventors: Jake Kavaler, Pound Ridge, NY (US); Zachary Spar, Chappaqua, NY (US)

(21) Appl. No.: 17/804,395

(22) Filed: May 27, 2022

Related U.S. Application Data
(60) Provisional application No. 63/194,222, filed on May 28, 2021.

(51) Int. Cl. G06F 16/435; G06F 16/48; G06F 16/438; G06N 20/00

(52) U.S. Cl. CPC G06F 16/435; G06F 16/48; G06F 16/438; G06N 20/00

(57) ABSTRACT

A content interaction system comprising at least one processor and memory hardware. The memory hardware stores a content item database configured to store a set of content items, a user database configured to store a set of user identifiers corresponding to account holders, and instructions for execution by the at least one processor. The instructions include, in response to a user device navigating to a first screen, obtaining a set of parameters corresponding to a first user identifier associated with the user device from the user database, implementing a machine learning algorithm to retrieve a set of content items from the content item database based on the set of parameters, and transforming a user interface of the user device based on the set of content items.

### CROSS-REFERENCE TO RELATED APPLICATIONS

This application claims the benefit of U.S. Provisional Application No. 63/194,222 filed May 28, 2021. The entire disclosure of the application referenced above is incorporated by reference.

### FIELD

The present disclosure relates to systems and methods for providing and obtaining access to content items included in a content item database.

### BACKGROUND

With a variety of different applications available on user devices, users are able to connect with one another using a variety of platforms.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A content interaction system comprising at least one processor and memory hardware. The memory hardware stores a content item database configured to store a set of content items, a user database configured to store a set of user identifiers corresponding to account holders, and instructions for execution by the at least one processor. The instructions include, in response to a user device navigating to a first screen, obtaining a set of parameters corresponding to a first user identifier associated with the user device from the user database, implementing a machine learning algorithm to retrieve a set of content items from the content item database based on the set of parameters, and transforming a user interface of the user device based on the set of content items.

In further aspects, the instructions include training the machine learning algorithm using a training dataset.

In further aspects, the training dataset includes a plurality of content items, corresponding user interactions with the plurality of content items, and a relevance score.

In further aspects, the instructions include, in response to receiving a review item from a review user device, identifying a corresponding content item indicated in the review item; associating the review item with the corresponding content item; and publishing the review item to the content item database and the user database indicating a reviewer identifier associated with the review user device.

In further aspects, the instructions include, in response to receiving a new content item, publishing the new content item to a feed, the feed including a plurality of content items, and the feed being a page users can view on the content interaction system.

In further aspects, the instructions include, at threshold intervals, determining an average rating for each content item of the set of content items, wherein the average rating is based on each rating of corresponding content item.

In further aspects, the instructions include, at threshold intervals, determining an average rating for each user identifier of the set of user identifiers, wherein the average rating is based on each rating of the corresponding user identifier.

In various embodiments of the present disclosure, a method of content interaction is provided. In some embodiments, the method can include, in response to a user device navigating to a first screen, obtaining a set of parameters corresponding to a first user identifier associated with a user device from a user database, the user database storing a set of user identifiers corresponding to account holders. The method can also include implementing a machine learning algorithm to retrieve a set of content items from a content item database based on the set of parameters, the content item database storing a set of content items. The method can also include transforming a user interface of the user device based on the set of content items.

In various embodiments of the present disclosure, a non-transitory computer readable medium is provided. The non-transitory computer readable medium can have instructions stored thereon, wherein the instructions, when executed by at least one processor, cause a device to perform operations that include, in response to a user device navigating to a first screen, obtaining a set of parameters corresponding to a first user identifier associated with a user device from a user database, the user database storing a set of user identifiers corresponding to account holders. The operations can also include implementing a machine learning algorithm to retrieve a set of content items from a content item database based on the set of parameters, the content item database storing a set of content items. The operations can also include transforming a user interface of the user device based on the set of content items.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIGS. 1A-1B are examples of a high-level functional block diagram depicting a content interaction system.

FIG. 2 is an example user interface of a content interaction system.

FIGS. 3A-3B are example data structures included in a content interaction system.

FIG. 4 is an example functional block diagram of a content interaction module within a content interaction system.

FIG. 5 is an example functional block diagram of a content query module within a content interaction system.

FIG. 6 is an example functional block diagram of a recommendation module within a content interaction system.

FIG. 7 is an example flowchart depicting content item recommendation.

FIGS. 8A-10B are example user interfaces of a content interaction system.

FIG. 11 is an example flow diagram depicting content item and user review process.

In the drawings, reference numbers may be reused to identify similar and/or identical elements.

### DETAILED DESCRIPTION

A content interaction system may implement an application on user devices to connect musicians and music lovers. More specifically, the content interaction system provides musicians a platform to upload content and receive constructive criticism and/or feedback from other users.

The content interaction system platform is used by musicians, listeners, and/or both. Musicians have the ability to upload music and video directly to the content interaction system platform. Musicians and listeners have the ability to purchase in-application currency or value. The currency can be used to fund marketing campaigns in order to reach a larger audience. The in-application currency can also be used for arbitrary gratuity and donations to “support” other users. Users can earn in-application currency by reviewing other user's content.

The content interaction system allows users upload content for others to interact with, including listening, reviewing, rating, etc. When a user pays to promote themselves on other platforms, the platform may receive 100% of interaction revenue. On the content interaction system, users earn money for interacting with that content. In various implementations, the content interaction system allow offers free streaming of content.

The content interaction system may have an API backend that stores all of the user information, content, interactions that users make, etc. within a set of databases. Content is recommended to the users based on preferred genres, tags, artists, interactions, etc. using machine learning algorithms as well as relevance values.

Additionally, the content interaction system allows users to upload content items, review and engage with content items, create new user connections, and curate a music library and playlists. Users can share content with other users in the content interaction system as well as to people without an account. Users can purchase and cash out in-application currency and get paid via third party entities (for example, PayPal, Inc.®, CashApp®, Venmo®, etc.).

In various implementations, the content interaction system provides the ability for users to directly pay other users for their subjective reviews and feedback. Further, the content interaction system allows users to monetize their opinions by reviewing artists and establishing credibility as a reviewer. The content interaction system also provides a platform for artists to monetize their content and receive support from their fans. On other streaming applications, artists may earn money based on a streaming amount, for example, which can present issues for artists to receive meaningful monetary feedback. Instead, the content interaction system allows users to directly support artists monetarily. Therefore, a user or artist's success and revenue is not dependent on their streaming numbers. Users can earn money directly from other users who support them. There is a “support” feature present on all content uploaded to the content interaction system as well as on all user profiles.

The content interaction system further includes a curated feed of content based on user listening preferences and past interactions including personalized recommended content items. Using the content interaction system, users may also directly submit their music to curators for review and playlist consideration. The content interaction system is further a social media platform with prominent music promotion and streaming features, providing a novel combination of features in a system or application, allowing musicians to connect with other musicians and fans to directly support their favorite artists and connect with them in a way they never could before.

To create an account through the content interaction system, the user inputs their information, including demographic information such as name/username, birthday, etc., along with content genre preferences, etc. To verify the user, the content interaction system may require a telephone number to generate the account. The provided number may then be sent a code for the user to verify access to the user device associated with the phone number. In various implementations, the user may perform the same authentication using an email address. In various implementations, the content interaction system uses JSON Web Token authentication to authenticate and verify the user.

Once a user is verified, they have access to do basic user actions. This includes browsing the application, creating an archive of posts, sending friend requests, creating playlists, buying currency, writing reviews, rating content, etc. There are many things the user can do once verified on the application and has the proper authorization to access the content.

The user may also upload content items. When a content item is uploaded, such as music, the content interaction system transforms the raw data file into a streaming format for bandwidths over WiFi and cellular networks. The content item is stored in a content item database. In various implementations, the databases used in the content interaction system may be an AWS product in the virtual-private subnet of AWS root user's Virtual Private Cloud (VPC). The databases are not accessible to the public in any way shape or form and are only accessible on the private network, through an instance clone of the content interaction system.

In various implementations, the content items are stored in a privatized AWS storage bucket, while the transformed or transcoded HTTP Live Stream (HLS) files are kept in a cloud caching distribution system, which is only accessible by signed cookies over an authenticated session. That is, a user's uploaded, original content items are not accessible, while the HLS files are accessible via proper authentication. Therefore, another user can only access HLS files to stream content items upon proper login and authentication through the content interaction system. Additional databases of the content interactions system include a user database storing user information, content, and tracking user interaction with the content interaction system.

When uploading the content item, the user includes information corresponding to the content item, including media file, cover art file, song name, artist name, genre, tags list, and a description. In various implementations, machine learning algorithms may analyze the input information to identify a genre, tag, description, etc. of the content item and/or generate a transcript.

Users interact with content and other users on the content interaction system. Every single interaction a user makes, for example, sending friend request, liking a content item, writing a review, the average rating left by the user, etc. is used to determine a set of recommended content items on a personalized feed of the user. In various implementations, the content interaction system calculates a relevance value of content items on the content interaction system and rank the content item for each user based on the user's preferences in genre/tags as well as the user's past interactions, such as “likes” for certain content items or consumption of content items, on the content interaction system. In various implementations, the content interaction system may select a set of content items most relevant to each user to recommend to the user. Additionally or alternatively, the content interaction system may incorporate a level of randomness in the order in which those content items already deemed relevant to the user are displayed to the user.

In various implementations, users can search for content items on the content interaction system. The user may enter a query and the content interaction system performs a relevance vector calculation to respond with the highest ranking hits in the calculation. That is, at threshold intervals, for example, weekly, the content interaction system determines a reverse index of the content items stored in the content item database based on a set of salient terms. Then, when a user enters a search query, the content interaction system can identify those content items relevant to the query based on how relevant the content items were to the salient terms. In various implementations, the content interaction system may determine the relevance of the content item or reverse index based on a term frequency within the content item.

The content interaction system may be made up of a server group called an ‘Auto Scaling’ (AS) group. This server group contains individual ‘clones’ of the application source code and build. The AS group sits behind a Load Balancer. The AS group spins up or spins down more clone instances based on a response to the traffic load of the application, and the CPU throughput threshold of the individual server clones. The Load Balancer accepts all of the incoming traffic and deals it out accordingly to each of the server clones in the AS group, improving user interaction and experience with the content interaction system.

In various implementations, as a user can friend another user, users can also “block” or “avoid” certain user's or content. Additionally, the in-application currency is an equilibrium system that always sums to zero. The content interaction system implements a double ended book system to keep track of transactions between users. In various implementations, when a user removes their in-application currency to receive money through a third-party, a fee may be removed by an operator or administrator and the amount is manually transferred to the user.

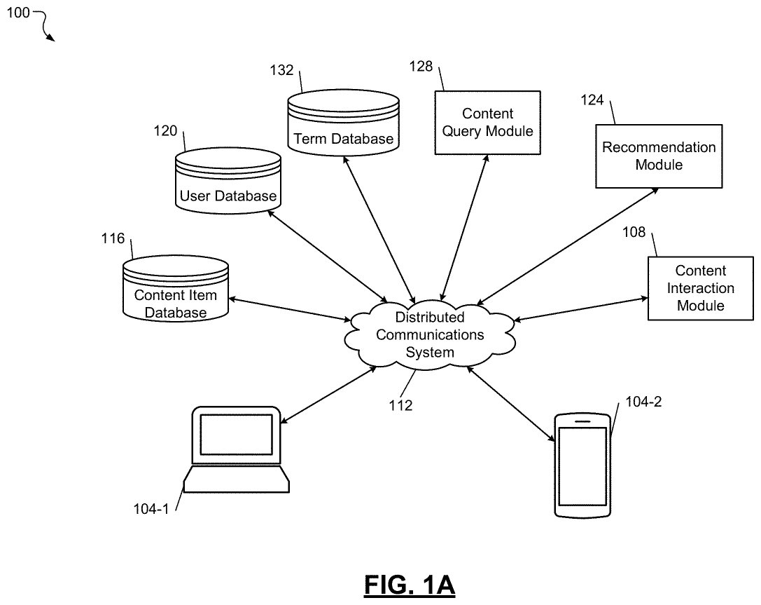

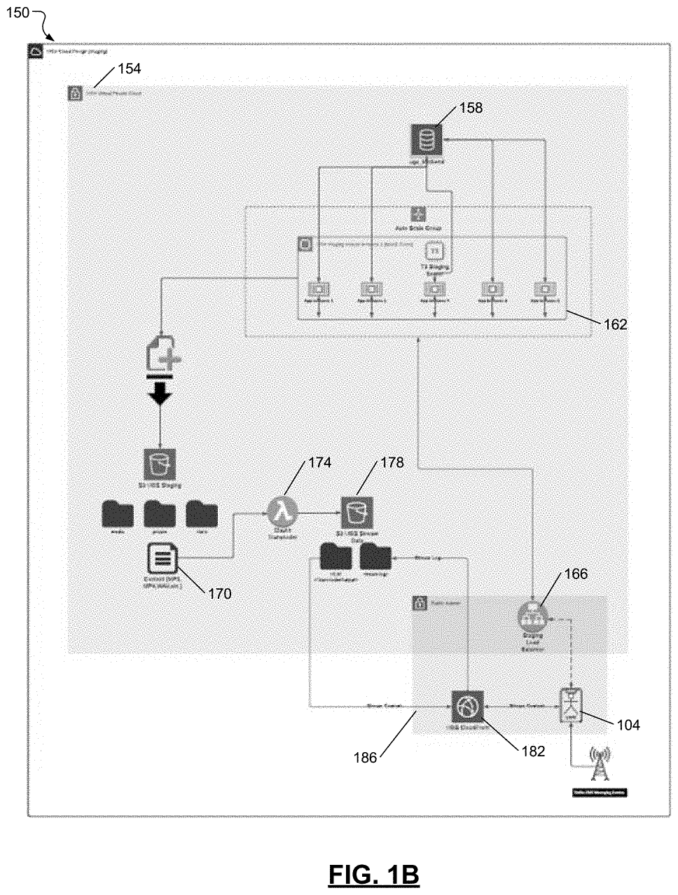

FIG. 1A is an example of a high-level functional block diagram depicting a content interaction system 100. User devices 104-1 and 104-2 (collectively user device 104) may be mobile computing devices, such as a mobile phone, tablet, laptop, etc. or a computing device, such as a desktop computer, through which a user can access and interact with the content interaction system 100. A content interaction module 108 may be accessed by the user device 104 via a distributed communications system 112. While FIG. 1A depicts all communications between devices, modules, and databases as through the distributed communications system 112 (for example, WiFi, near field communication systems, etc.), the devices, modules, and databases may communicate directly on an internal network.

The content interaction module 108 allows users to upload content items to a content item database 116 using the user device 104 as well as interact with content items, including streaming, rating, reviewing, supporting, etc. The content item database 116 stores uploaded content items as well as identifiers or information corresponding to the content items. Additionally, a user database 120 stores user account information for each user or user identifier who has an account, including tracking user interaction with the content interaction system 100. A recommendation module 124 generates a recommendation list for users based on the user's profile and user interaction information (clicks, likes, reviews, etc.).

A content query module 128 operates to provide a results list of content items based on a query received from the user device 104. As noted above, in various implementations, the content query module 128 may determine a relevance score of a particular content item to a set of salient terms stored in a term database 132. The content query module 128 may determine the various relevance scores at threshold intervals, such as daily, weekly, etc.

FIG. 1B depicts a backend staging design 150 of the content interaction system also depicted in FIG. 1A. A private cloud 154 includes a backend 158 communicating with a plurality of application instances 162 in an auto scale group of a server. Incoming traffic from the user device 104 is managed by a load balancer 166, which forwards the traffic to one of the plurality of application instances 162. Received content items 170 are transcoded by a transcoder 174 into a streaming format 178, which are accessible for streaming via CloudFront 182 on the user device 104. The user device 104 can access the streaming content via a public subnet 186 via CloudFront 182.

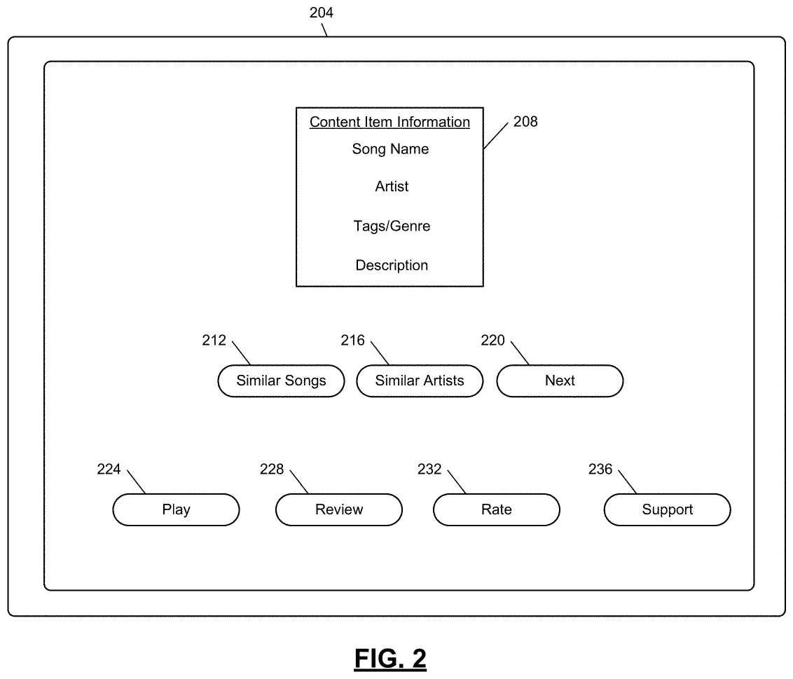

FIG. 2 is an example user interface 204 of the content interaction system. The example user interface 204 depicts when a user interacts with a particular content item. The user interface 204 may display content item information 208, including a song name, artist, tags/genre, description, etc. The user is also presented with a variety of user-selectable buttons to view similar songs 212, view similar artists 216, or view a next song 220 or content item (for example, a next recommended song).

Additionally, the user may play 224 the content item (this button may switch to pause/stop when the content item is playing), review 228 the content item, rate 232 the content item, and/or support 236 the content item (by sending the artist in-application currency).

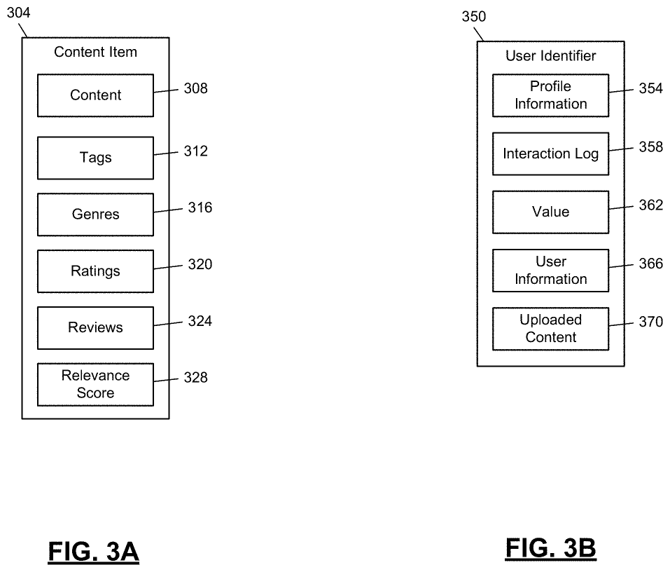

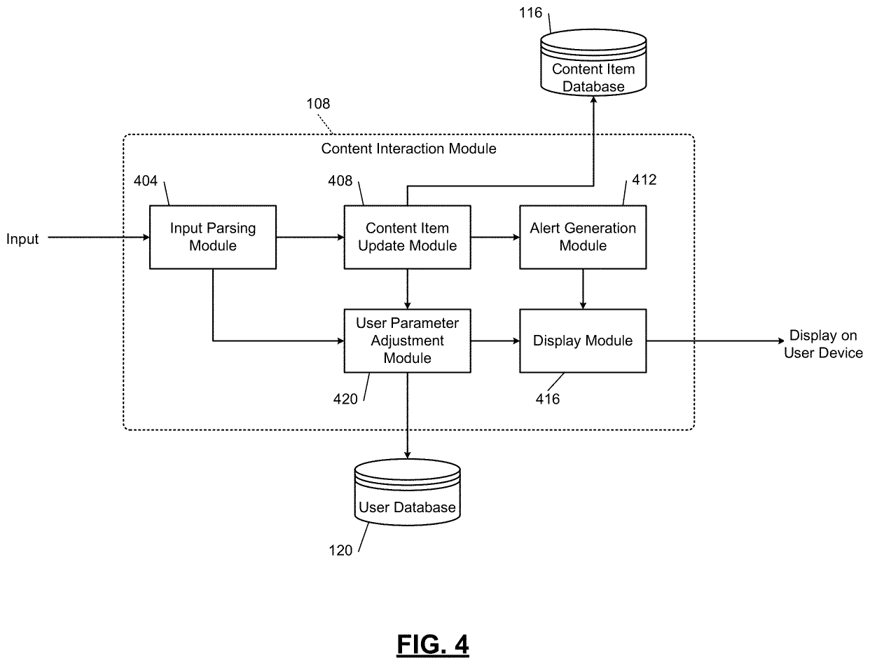

FIGS. 3A-3B are example data structures included in a content interaction system. For example, the content item database 116 previously described stores a plurality of content items. FIG. 3A shows a content item 304 (or a content item identifier), which may include content 308, tags 312, genres 316, ratings 320, reviews 324, and relevance scores 328 to particular terms/users.

FIG. 3B depicts a user identifier 350, which may be stored in the user database 120 along with a plurality of user identifiers corresponding to user accounts. The user identifier 350 may include profile information 354 (friends, blocks, etc.), interaction log 358 (tracking all clicks, streams, likes, reviews, ratings, etc.), value 362 corresponding to an amount of in-application currency, user information 366 (phone number, age, email, etc.), and uploaded content 370.

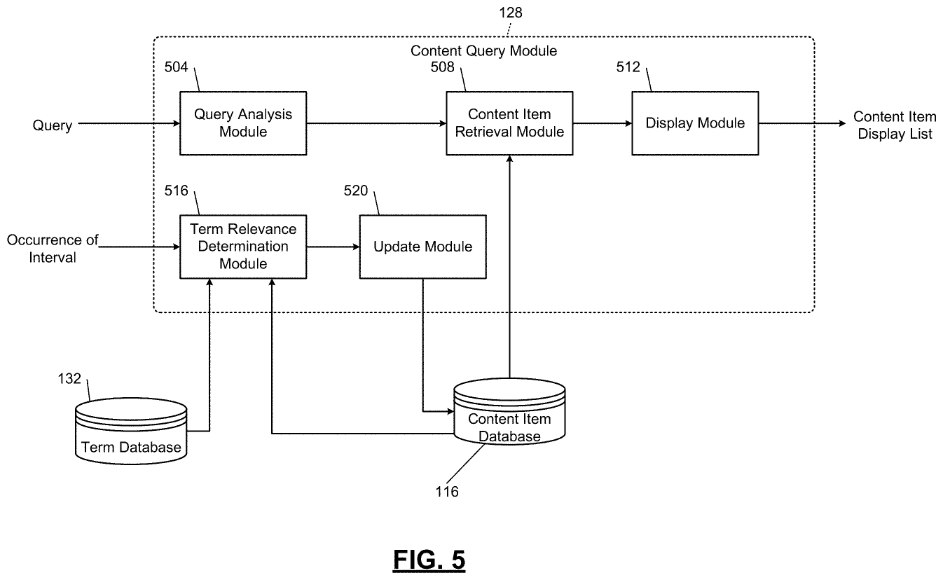

FIG. 4 is an example functional block diagram of the content interaction module 108 within the content interaction system 100. The content interaction module 108 includes an input parsing module 404 that may receive a variety of different types of input from a user device, such as an upload request, a user selection to store, a user rating/review to post and store, etc. The input parsing module 404 determines if the user is uploading a new content item and forwards the upload request to a content item update module 408. The content item update module 408 adds the content item to the content item database 116. In various implementations, the content item update module 408 may reject or flag the content item if the user has not provided the requisite information or the uploaded content item does not match an acceptable file format and forward the request to an alert generation module 412. The alert generation module 412 forwards the alert to a display module 416 for display on the user device.

When the content item update module 408 uploads the content item to the content item database 116, the content item update module 408 also forwards an indication to a user parameter adjustment module 420 to update the user database 120 to indicate in the user's user identifier that the content item was uploaded by the user.

Returning to the input parsing module 404, if the input parsing module 404 determines that the input is a user interaction with an existing content item or other user, the input parsing module 404 forwards the input to the user parameter adjustment module 420 to update the user's user identifier in the user database 120. For example, if the user added a new friend or reviewed a content item, the interaction is recorded in the user database 120.

FIG. 5 is an example functional block diagram of the content query module 128 within the content interaction system 100. The content query module 128 includes a query analysis module 504 configured to receive a query from a user device. The query analysis module 504 parses the individual terms within the query. The terms are forwarded to a content item retrieval module 508 that obtains a set of content items from the content item database 116 based on the corresponding relevance score for the identified terms. For example, the content item retrieval module 508 obtains those content items with a relevance score for the identified terms that is above a threshold value. The content items (or content item identifiers) are forwarded to a display module 512 for display to the user on the user device.

The content query module 128 also includes a term relevance determination module 516 that is prompted at threshold intervals. As noted above, the term relevance determination module 516 may be prompted to determine a relevance score each week. The term relevance determination module 516 obtains a set of terms for a term database 132 that are common enough to be included in queries and therefore the content interaction system determines a relevance score corresponding to content items for each term.

The term relevance determination module 516 also obtains content items from the content item database 116 and determines how relevant each term is to the content items. As previously described, the term relevance determination module 516 may implement a structured or unstructured machine learning algorithm (such as determining a similarly using k-means clustering) or natural language processing to determine the relevance score for each term. Additionally or alternatively, the term relevance determination module 516 may use a reverse index for the terms to determine a term frequency within the content items. The relevance scores for the content items are forwarded to an update module 520 to update the corresponding relevance scores corresponding to each content item in the content item database 116.

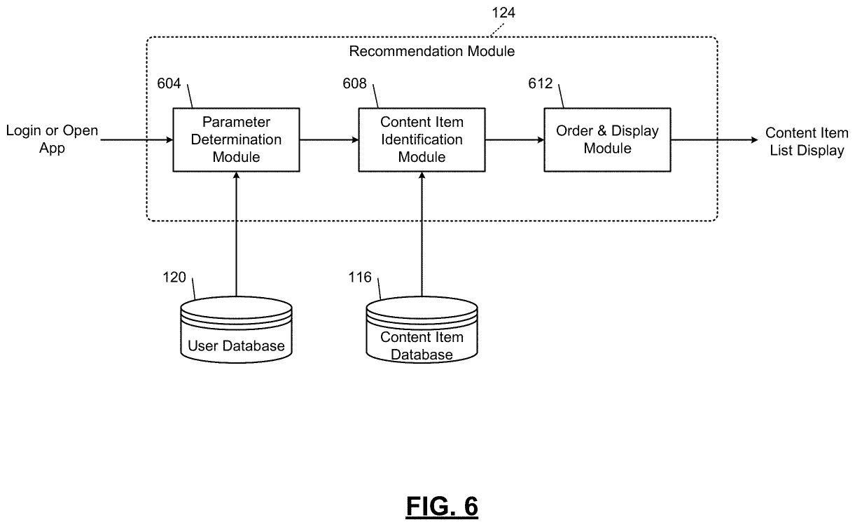

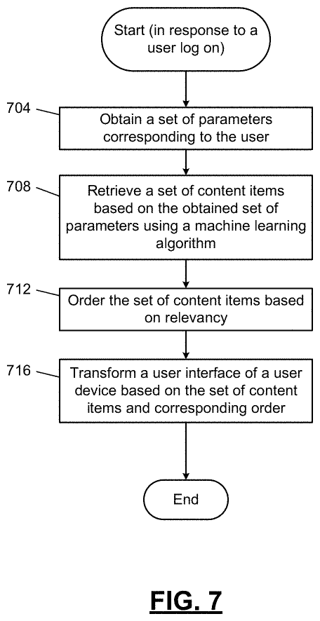

FIG. 6 is an example functional block diagram of the recommendation module 124 within the content interaction system 100. The recommendation module 124 includes a parameter determination module 604 that is prompted by a user logging in or opening the content interaction system or application. That is, when a user logs on, a list of recommended content items may be displayed to a user on a home screen or subsequent recommendation screen. The parameter determination module 604 obtains the user identifier for the user from the user database 120. Specifically, the parameter determination module 604 determines which user parameters of the user database 120 are relevant to content item recommendations. In various implementations, an operator of the content interaction system may adjust the weighting or impact of certain parameters on the content item recommendations by adjusting the parameter determination module 604, even excluding some parameters.

The obtained parameters are forwarded to a content item identification module 608 that implements a machine learning algorithm to identify which content items to obtain from the content item database 116. Again, as noted above, the content item identification module 608 may implement a variety of artificial intelligence techniques, including but not limited to structured learning, unstructured learning, natural language processing, k-means clustering, etc. The set of content items selected may be those content items above a particular similarity or relevance threshold determined by the content item identification module 608. Therefore, in some implementations, the content item identification module 608 may not return any content items. Once a set of content item identifiers are obtained from the content item database 116, the content item identifiers are forwarded to an order and display module 612. The order and display module 612 may order the content items randomly, based on relevance, alphabetically, etc. then forward the content item list for display to the user on the user device.

FIG. 7 is an example flowchart depicting content item recommendation. Control begins in response to a user logging on to a user device. In various implementations, control may begin in response to a user navigating to a content item recommendations page of the content interaction system. Control continues to 704 to obtain a set of parameters corresponding to the user. Control proceeds to 708 to retrieve a set of content items based on the obtained set of parameters using a machine learning algorithm. Control continues to 712 to order the set of content items based on relevancy. As described above, control may order the content items randomly or according to another parameter. Control proceeds to 716 to transform a user interface of the user device based on the set of content items and the corresponding order. Then, control ends.

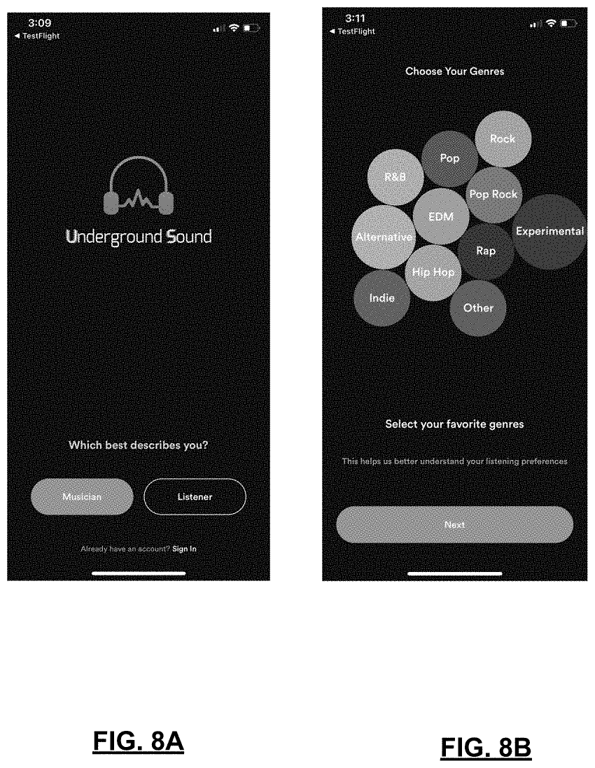

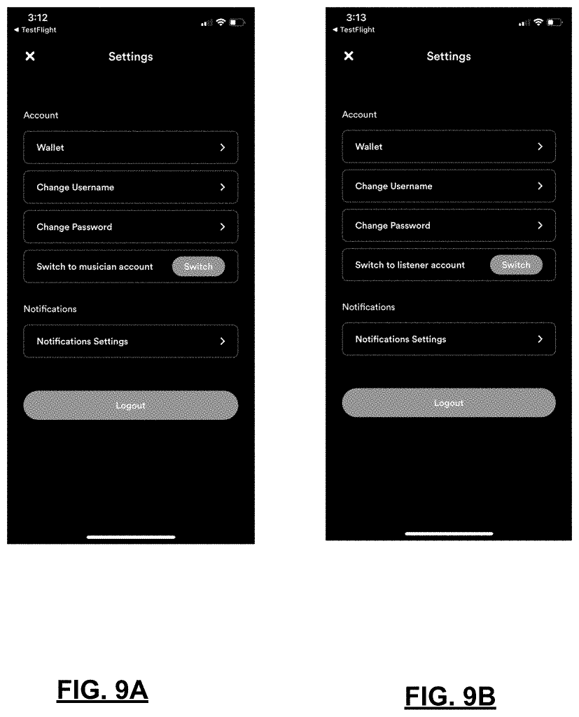

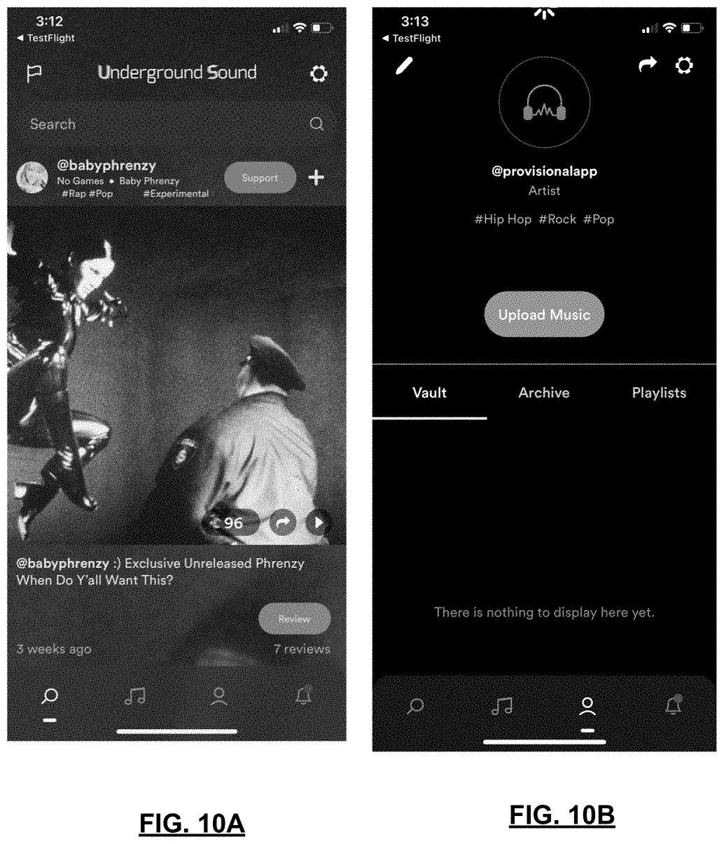

FIGS. 8A-10B are example user interfaces of a content interaction system depicting screens to set up an account, stream music, etc.

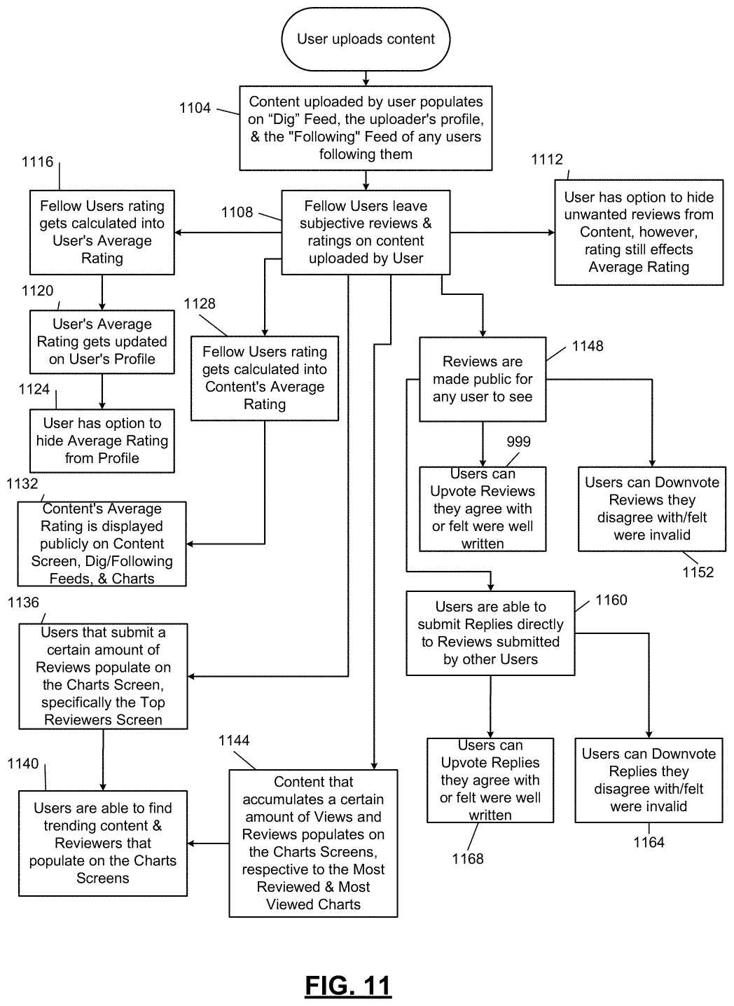

Referring now to FIG. 11, an example flow diagram depicting content item and user review process by platform users is shown. The flow diagram begins when a user uploads content. Then, at 1004, the content that is uploaded by the user (for example, a musician) is published or populates on the “dig” feed, the uploader's profile, and/or the “following” feed of any users following the uploader. Continuing to 1108, the fellow users are then able to leave their subjective reviews and ratings on the uploaded content. From 1108, there are multiple options for musician users and following users to interact with uploaded content. After 1108, the flow diagram can continue to 1112, which indicates that the user had option to hide unwanted reviews from the content item.

Additionally, the flow diagram continues to 1116 to allow fellow users ratings to be combined or calculated into the user's average rating. The flow diagram continues to 1120 where the user's average rating gets updates on the user's profile—the user being the one who adds the content item. The flow diagram continues to 1124 where the user has the option to hide the average rating from their profile. From 1108, the flow diagram also continues to 1128 where fellow user rating is combined or calculated into the content item's average rating. Then, the flow diagram can continue to 1132 where the content item's average rating is displayed publicly on the content item's corresponding screen, on the dig/following feed, and on charts. In various implementations, the average rating for a content item or a user may be determined at threshold intervals, for example, hourly, daily, etc.

From 1108, the flow diagram can also continue to 1136 where users that submitted a certain amount of reviews are published or populated on the charts screen. For example, in various implementations, those reviews of the top reviewers are published on the top reviewers screen. The flow diagram can continue to 1140 where users are able to find tending content and reviewers that have reviews published on the charts screen. From 1108, the flow diagram can also continue to 1144 where content that accumulates a certain amount of views and reviews is published or populated on the charts screen, along with the most reviewed and most viewed charts.

From 1108, the flow diagram can also continue to 1148 where reviews are made public for any user to see. The flow diagram can continue to 1152 where users can downvote reviews they disagree with or felt were invalid. From 1148, the flow diagram can also continue to 1156 where users can upvote reviews they agree with or felt were well written. The flow diagram can also continue to 1160 from 1148 where users are able to submit replies directly to reviews submitted by other users. From 1160, the flow diagram can continue to 1164 where users can downvote replies they disagree with or felt were invalid, and, additionally, the flow diagram can continue to 1168, where users can upvote replies they agree with or felt were well written.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A content interaction system comprising:
at least one processor; and
memory hardware, wherein the memory hardware stores:
a content item database configured to store a set of content items;
a user database configured to store a set of user identifiers corresponding to account holders; and
instructions for execution by the at least one processor, wherein the instructions include, in response to a user device navigating to a first screen:
obtaining a set of parameters corresponding to a first user identifier associated with the user device from the user database;
implementing a machine learning algorithm to retrieve a set of content items from the content item database based on the set of parameters; and
transforming a user interface of the user device based on the set of content items.

2. The content interaction system of claim 1 wherein the instructions include training the machine learning algorithm using a training dataset.

3. The content interaction system of claim 2 wherein the training dataset includes a plurality of content items, corresponding user interactions with the plurality of content items, and a relevance score.

4. The content interaction system of claim 1 wherein the instructions include, in response to receiving a review item from a review user device, identifying a corresponding content item indicated in the review item; associating the review item with the corresponding content item; and publishing the review item to the content item database and the user database indicating a reviewer identifier associated with the review user device.

5. The content interaction system of claim 1 wherein the instructions include, in response to receiving a new content item, publishing the new content item to a feed, the feed including a plurality of content items, and the feed being a page users can view on the content interaction system.

6. The content interaction system of claim 1 wherein the instructions include, at threshold intervals, determining an average rating for each content item of the set of content items, wherein the average rating is based on each rating of corresponding content item.

7. The content interaction system of claim 1 wherein the instructions include, at threshold intervals, determining an average rating for each user identifier of the set of user identifiers, wherein the average rating is based on each rating of the corresponding user identifier.

8. A content interaction method comprising:
in response to a user device navigating to a first screen, obtaining a set of parameters corresponding to a first user identifier associated with a user device from a user database, the user database storing a set of user identifiers corresponding to account holders;
implementing a machine learning algorithm to retrieve a set of content items from a content item database based on the set of parameters, the content item database storing a set of content items; and
transforming a user interface of the user device based on the set of content items.

9. The content interaction method of claim 8 further comprising training the machine learning algorithm using a training dataset.

10. The content interaction method of claim 9 wherein the training dataset includes a plurality of content items, corresponding user interactions with the plurality of content items, and a relevance score.

11. The content interaction method of claim 8 further comprising, in response to receiving a review item from a review user device, identifying a corresponding content item indicated in the review item; associating the review item with the corresponding content item; and publishing the review item to the content item database and the user database indicating a reviewer identifier associated with the review user device.

12. The content interaction method of claim 8 further comprising, in response to receiving a new content item, publishing the new content item to a feed, the feed including a plurality of content items, and the feed being a page users can view on the content interaction system.

13. The content interaction method of claim 8 further comprising, at threshold intervals, determining an average rating for each content item of the set of content items, wherein the average rating is based on each rating of corresponding content item.

14. The content interaction method of claim 8 further comprising, at threshold intervals, determining an average rating for each user identifier of the set of user identifiers, wherein the average rating is based on each rating of the corresponding user identifier.

15. A non-transitory computer readable medium having instructions stored thereon, wherein the instructions, when executed by at least one processor, cause a device to perform operations comprising:
in response to a user device navigating to a first screen, obtaining a set of parameters corresponding to a first user identifier associated with a user device from a user database, the user database storing a set of user identifiers corresponding to account holders;
implementing a machine learning algorithm to retrieve a set of content items from a content item database based on the set of parameters, the content item database storing a set of content items; and
transforming a user interface of the user device based on the set of content items.

16. The non-transitory computer-readable medium of claim 15 wherein the operations further comprise training the machine learning algorithm using a training dataset.

17. The non-transitory computer-readable medium of claim 16 wherein the training dataset includes a plurality of content items, corresponding user interactions with the plurality of content items, and a relevance score.

18. The non-transitory computer-readable medium of claim 15 wherein the operations further comprise, in response to receiving a review item from a review user device, identifying a corresponding content item indicated in the review item; associating the review item with the corresponding content item; and publishing the review item to the content item database and the user database indicating a reviewer identifier associated with the review user device.

19. The non-transitory computer-readable medium of claim 15 wherein the operations further comprise, in response to receiving a new content item, publishing the new content item to a feed, the feed including a plurality of content items, and the feed being a page users can view on the content interaction system.

20. The non-transitory computer-readable medium of claim 15 wherein the operations further comprise, at threshold intervals, determining an average rating for each content item of the set of content items, wherein the average rating is based on each rating of corresponding content item.
